(19) United States
(12) Patent Application Publication
(10) Pub. No.: US 2015/0017946 A1
(43) Pub. Date: Jan. 15, 2015

(54) METHOD AND APPARATUS FOR LIMITING THE COLLECTION OF CELLULAR IDENTIFYING INFORMATION TO DEFINED AREAS

(71) Applicant: L3 Communications-ASIT, Linthicum Heights, MD (US)

(72) Inventor: James D. Haverty, Meredith, NH (US)

(21) Appl. No.: 14/323,129

(22) Filed: Jul. 3, 2014

Related U.S. Application Data
(60) Provisional application No. 61/844,606, filed on Jul. 10, 2013.

(51) Int. Cl. H04W 12/08

(52) U.S. Cl. CPC H04W 12/08
USPC 455/410

(57) ABSTRACT

A system includes an interrogating transceiver that is calibrated using range transceivers. After calibration, the interrogating transceiver may bait cellular devices within a use-prohibited area, identify responding devices, and initiate corrective actions regarding the identified cellular devices.

### CROSS-REFERENCE TO RELATED APPLICATION

This application claims priority under 35 U.S.C. §119 to provisional application 61/844,606, entitled METHOD AND APPARATUS FOR LIMITING THE COLLECTION OF CELLULAR IDENTIFYING INFORMATION TO DEFINED AREAS, filed on Jul. 10, 2013, the disclosure of which is hereby incorporated by reference in its entirety.

### TECHNICAL FIELD

Exemplary embodiments in accordance with principles of inventive concepts determine the identification of a cellular device.

### DISCUSSION OF RELATED ART

Cellular devices, which may include telephones, smartphones, or tablet computers, for example, have revolutionized the communications industry, due, in large part, to their mobility, convenience and ubiquity. Their use can, literally, save lives. Unfortunately, their convenience may also allow cellular devices to be used in areas where their use poses a hazard to others. For example, cellular devices are often smuggled into incarceration units, such as prisons or jails, where criminals may use them to carry out ongoing criminal activities, to intimidate or eliminate witnesses, or to otherwise corrupt the justice process. Their use is also often prohibited in construction zones, blasting zones, or other areas where their use could pose a hazard. Such areas of concern may be referred to herein as use-prohibited areas.

Various approaches have been used to identify and terminate such illicit cellular device usage. For example, service providers may employ a baiting beacon (also referred to herein as an interrogator) to interrogate cellular devices in use within an area in which cellular device usage is prohibited. When a cellular device responds to the beacon, the device reveals its identity and the service provider can then terminate use of the device.

However, legitimate users may operate their cellular devices immediately proximate a prohibited area, and the boundaries between use-prohibited and allowed-use areas may be somewhat blurred and fluid. That is, weather, seasonal changes, solar activity, and other factors can alter cellular device response and transceiver range on an ongoing basis. The boundary between allowed and illicit cellular device activity areas may likewise vary. As a result, service providers and others face challenges in denying service to, or otherwise dealing with, illicit users while, at the same time, allowing legitimate use.

### SUMMARY

In various embodiments a method in a cellular communications system includes, an interrogating transceiver calibrating itself by transmitting a cellular signal from within a use-prohibited area, a range transceiver receiving the signal; and the interrogating transceiver adjusting the range of its signals according to a response from the range transceiver.

In various embodiments a method in a cellular communications system includes an interrogating transceiver adjusting the range of its signals by adjusting the power level of its transmissions.

In various embodiments a method in a cellular communications system includes an interrogating transceiver adjusting the range of its signals by setting its power output level to high level and adjust the power output level downward until a range transceiver no longer responds to its interrogation signal.

In various embodiments a method in a cellular communications system includes an interrogating transceiver adjusts the range of its signals by setting its power output level to low level and adjust the power output level upward until a range transceiver responds to its interrogation signal.

In various embodiments a method in a cellular communications system includes an interrogating transceiver adjusting the range of its signals according to responses from a plurality of range transceivers.

In various embodiments a method in a cellular communications system includes identities of the plurality of range receivers being known to the interrogating transceivers and the identities are employed by the interrogator to avoid interaction with cellular devices outside the use-prohibited area other than the range transceivers.

In various embodiments a method in a cellular communications system includes different range transceivers assigned to different service providers whether realized or virtual.

In various embodiments a method in a cellular communications system includes different range transceivers assigned to different cellular transmission channels.

In various embodiments a method in a cellular communications system includes an interrogating transceiver calibrated using a range transceiver outside a use-prohibited area baiting cellular devices, the interrogating transceiver obtaining identity information from cellular devise that signal in response to the baiting signals, the interrogating transceiver identifying responding cellular devices, and the interrogating transceiver initiating a response to identified cellular devices operating within a use-prohibited area.

In various embodiments a method in a cellular communications system includes a response initiated by the interrogating transceiver is termination of service.

In various embodiments a system in a cellular communications system includes an interrogating transceiver positioned within a use-prohibited area; and a range transceiver positioned outside the use-prohibited area, wherein the interrogating is configured to be calibrated by transmitting a cellular signal from within a use-prohibited area, the range transceiver receiving the signal, and the interrogating transceiver adjusting the range of its signals according to a response from the range transceiver.

In various embodiments a system in a cellular communications system includes an interrogating transceiver configured to adjust the range of its signals by adjusting the power level of its transmissions.

In various embodiments a system in a cellular communications system includes an interrogating transceiver configured to adjust the range of its signals by setting its power output level to high level and adjusting the power output level downward until a range transceiver no longer responds to its interrogation signal.

In various embodiments a system in a cellular communications system includes an interrogating transceiver configured to adjust the range of its signals by setting its power output level to low level and adjusting the power output level upward until a range transceiver responds to its interrogation signal.

In various embodiments a system in a cellular communications system includes an interrogating transceiver configured to adjust the range of its signals according to responses from a plurality of range transceivers.

In various embodiments a system in a cellular communications system includes an interrogating transceiver configured to store identities of the plurality of range receivers to use the identities to avoid interaction with cellular devices outside the use-prohibited area other than the range transceivers.

In various embodiments a system in a cellular communications system includes a plurality of range transceivers, each configured for a different service provider.

In various embodiments a system in a cellular communications system includes a plurality of range transceivers, each configured for a different cellular transmission channels.

In various embodiments a system in a cellular communications system includes an interrogating transceiver configured to obtain identity information from cellular device that signals in response to a baiting signal, the interrogating transceiver configured to identify responding cellular devices, and the interrogating transceiver configured to initiate a response to identified cellular devices operating within a use-prohibited area.

In various embodiments a system in a cellular communications system includes an interrogating transceiver configured to initiate termination of service.

### BRIEF DESCRIPTION OF THE DRAWINGS

The foregoing and other features and advantages of inventive concepts will be apparent from the more particular description of exemplary embodiments in accordance with principles of inventive concepts, as illustrated in the accompanying drawings in which like reference characters refer to the same parts throughout the different views. The drawings are not necessarily to scale, emphasis instead being placed upon illustrating the principles of inventive concepts. In the drawings:

FIG. 1 is a block diagram of a system 100 in accordance with principles of inventive concepts;

FIG. 2 is a schematic representation of an exemplary embodiment of a system 100 in an environment in which it may operate; and

FIG. 3 is a flow chart depicting an exemplary embodiment of a process such as may be employed by a system 100 in accordance with principles of inventive concepts.

### DETAILED DESCRIPTION

Various exemplary embodiments will be described more fully hereinafter with reference to the accompanying drawings, in which exemplary embodiments are shown. Exemplary embodiments may, however, be embodied in many different forms and should not be construed as limited to exemplary embodiments set forth herein. Rather, these exemplary embodiments are provided so that this disclosure will be thorough, and will convey the scope of exemplary embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. The term “or” is used in an inclusive sense unless otherwise indicated.

It will be understood that, although the terms first, second, third, for example. may be used herein to describe various elements, components, regions, layers and/or sections, these elements, components, regions, layers and/or sections should not be limited by these terms. These terms are only used to distinguish one element, component, region, layer or section from another region, layer or section. In this manner, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. In this manner, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to illustrations that are schematic illustrations of idealized exemplary embodiments (and intermediate structures). As such, variations from the shapes of the illustrations as a result, for example, of manufacturing techniques and/or tolerances, are to be expected. In this manner, exemplary embodiments should not be construed as limited to the particular shapes of regions illustrated herein but are to include deviations in shapes that result, for example, from manufacturing.

Processes may be described as including steps that proceed in a certain order, but inventive concepts are not limited thereto. Other sequences of steps, substitution or deletion of steps, or other processes are contemplated within the scope of inventive concepts.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

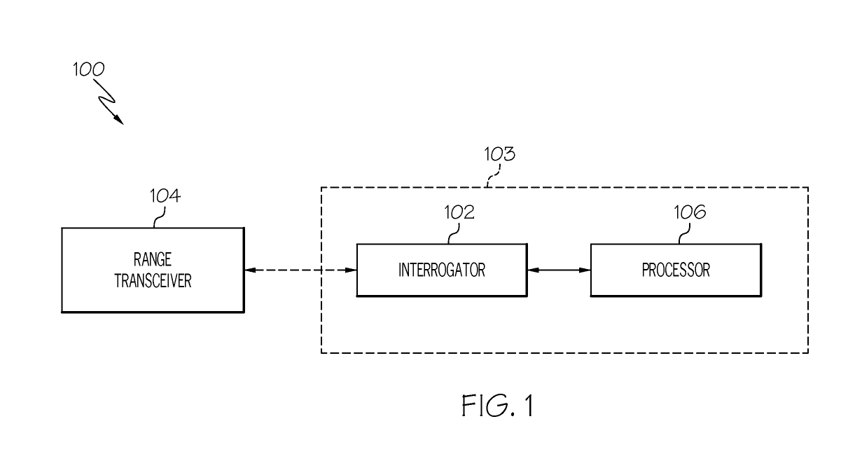

The block diagram of FIG. 1 depicts an exemplary embodiment of a system 100 in accordance with principles of inventive concepts that employs at least one interrogation transceiver, also referred to herein as interrogator 102 positioned within a use-prohibited zone 103, at least one range-transceiver 104, with known identification, located outside the use-prohibited zone and a processor 106 that may control operation of the interrogator 102. The range transceiver 104 may be simply, a cellular telephone with known identity, for example. In an exemplary method in accordance with principles of inventive concepts, the interrogator 102 employs the range transceiver 104 to determine an appropriate range of operation for the interrogator, adjusting, for example, the interrogator signal strength or other transmission parameter, including transmission direction, to avoid transmissions outside a use-prohibited zone 103. Multiple realized range transceivers may be separately incarnated or a set of virtual transceivers may be realized with a single transceiver employing a distributed antenna system and time multiplexing a signal to each antenna. By adjusting transmission parameters during such a range-determination mode, a system 100 in accordance with principles of inventive concepts may avoid interfering with operation of cellular devices located outside the use-prohibited zone 103 during a regular, or interrogating, operation mode, while, at the same time, identifying cellular devices within the use-prohibited zone 103 during the interrogating mode. System 100 may employ a temporary identifier, such as a temporary mobile service identifier (TMSI) obtained from a cellular device within use-prohibited zone 103 in response to an interrogation to identify an illicit device. That identity may be used, for example, in cooperation with a service provider to disable or otherwise intervene (record communications contents, for example) in the operation of the device.

In accordance with principles of inventive concepts the signal strength, antenna directionality or coverage pattern, or other characteristic of an interrogator 102 may be adjusted so that transmissions from the interrogator include an area from the interrogator location up to, but not including, a range transceiver 104. That is, adjustments may be made until transmission levels no longer elicit a response from range transceiver 104. Since the range transceiver 104 represents the border of permissible operation, it may be positioned as close to the prohibited zone 103 as possible, closer to the interrogator 103 than other cell phones in the non-prohibited zone, but still outside the prohibited zone 103 (or, at least, at a location beyond which transmission levels are to be below a predetermined threshold level). In an exemplary method in accordance with principles of inventive concepts interrogator 102 transmits a baiting signal and, when a range transceiver 104 responds, the interrogator iteratively reduces signal strength (or alters anther interrogator characteristic) and rebroadcasts the baiting signal until the range transceiver 104 no longer responds. Alternatively, the interrogator may transmit a baiting signal at a relatively low level, one at which the range transceiver 104 does not response, and increment the signal strength or other parameter and rebroadcast until the range transceiver 104 does respond. After determining the range in either fashion (incrementing or decrementing the interrogator range) during a range-determination mode, the transmission range may be reduces a predetermined amount in order to ensure that interrogating transmissions do not exceed a threshold level beyond a desired distance (beyond a boundary of a use-prohibited zone, for example). In exemplary embodiments, a baiting signal may be any signal that conforms to a cellular communications standard and which may prompt a cellular device to response with, for example, identification information, such as temporary identification information.

The interrogator 102 may begin transmitting the baiting signal with a signal strength that is known to encompass the range transceiver 104 and reduce signal strength from that known level or, for example, the interrogator 102 may begin transmitting the baiting signal and at a relatively low signal level and increase strength until the range transceiver 104 responds. That is, the interrogator 102 may employ a “creep up,” “creep down,” or combination of approaches using baiting signal strength adjustment, for example. Other baiting signal adjustments, such as antenna directionality, or coverage pattern are also contemplated within the scope of inventive concepts. Because the identity of the range transceiver 104 is known and the range transceiver is known to be located at an extreme of prohibited region 103, a system 100 in accordance with principles of inventive concepts may determine that a transceiver that responds to a baiting signal after the range transceiver 104 has ceased responding to the baiting signal is located within the prohibited zone 103 and the system 100 (through processor 106, for example) may identify the associated device, contact the associated service provider (through processor 106 and a network link, for example) and terminate service to or otherwise intervene with service to the illicit device.

In accordance with principles of inventive concepts a plurality of range transceivers 104 may be employed in a given location; one for each service provider, for example. Each range transceiver 104 may operate in different frequency bands or a plurality of range transceivers 104 may each be assigned a different frequency band. Range transceivers 104 or equivalently a single time and space multiplexed transceiver using a distributed antenna system may be positioned in a plurality of locations around a use-prohibited zone 103 in order to better define the boundaries of a use-prohibited zone 103 and a plurality of interrogators 102 also be employed to, likewise, better define the boundaries of a use-prohibited zone 103, particularly if the use-prohibited zone 103 is irregularly shaped, for example.

In accordance with principles of inventive concepts, each range transceiver 104 may be associated with (that is, may be a component of, for example) a cell phone or may be a transceiver emulating a cell phone. A range transceiver 104 or collection thereof may also be referred to herein as a transponder unit.

In accordance with principles of inventive concepts processor 106 may be coupled to interrogator 102 to control operation of the interrogator 102. In a range-determination mode, the processor 106 may establish an appropriate range for the interrogator signal, as described above, for example. In a “normal” mode, also referred to herein as an interrogation mode, whereby the interrogator 102 baits illicit cell phones within use-prohibited zone 103, the processor 106 may cause the interrogator 102 to cycle through different frequency bands, different service-provider protocols, determine whether a responding transceiver is associated with a known device identity, such as that associated with a range-transceiver 104, or, when it is determined that an illicit cell device is operating within a use-prohibited zone 103, may contact the appropriate service provider for termination of service to the illicit device. The processor 106 may enter a range-determination mode, whereby it induces the interrogator 102 and range transceiver 104 to update the interrogator's range, on a timed basis (which may be regular or intermittent), and/or may respond to environmental factors, such as weather conditions or solar storms, for example to initiate range-determination.

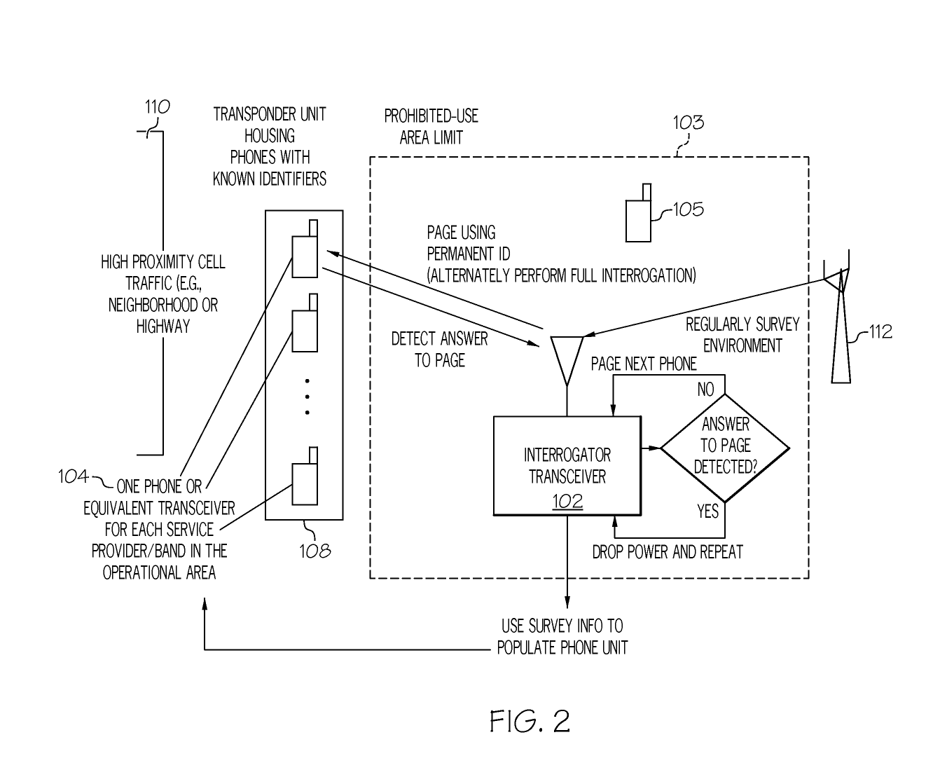

FIG. 2 is an exemplary embodiment of an interrogation unit 102 in accordance with principles of inventive concepts operating within a prohibited-use zone 103. One or more range transponder units 108 may be situated outside of the prohibited-use zone 103. Although range transponder units 108 may be employed to limit the range of interrogator transceiver 102 to a distance that ensures no cellular devices outside of use-prohibited area 103 are interfered with, range transponder units 108 need not be located directly on the boundary of use-prohibited area 103 if, for example, there is a buffer area between use-prohibited area 103 and the nearest cellular traffic area 110. Transponder unit 108 (which may include one or more range transceivers 104, which may be embodied as cellular telephones with known identities) may be placed between the use-prohibited area 103 boundary and any area use-permitted area 110 that may be sensitive to having phones inadvertently identified or otherwise subjected to unwelcome interference (e.g., a coffee shop near a prison unit).

In an exemplary embodiment in accordance with principles of inventive concepts, the transponder unit 108 may include one or more range transceivers (which may be embodied as cellular phones or other devices) that have engineering mode capabilities that would limit their operation to a specific frequency band. In accordance with principles of inventive concepts, there may be one phone for each service provider and band. The transponder unit 108 may include a power source and may be ruggedized to withstand the elements and attempts to sabotage the system, for example.

The interrogation transceiver 102 may be programmed with a permanent identifier for each phone 104, or transceiver emulating a phone, in the transponder unit 108. In operation, the interrogation unit may scan the environment and create a set of baiting beacons which are either neighbors or overriding clones of existing live beacons 112. In exemplary embodiments in accordance with principles of inventive concepts, the interrogation unit, or interrogator 102, by employing overriding clones or neighbors of existing live beacons covering the prohibited-use zone and using the same registration area information as those existing live beacons, cellular devices within the use-prohibited zone 103 will monitor traffic from the interrogator 102. During a range-determination operation, interrogator 102 may expressly page range-determination transceivers (also referred to herein as transponder phones 104), await a response, reduce/increase power, as appropriate, and proceed as described above with the establishment of appropriate transponder characteristics. In an exemplary embodiment in accordance with principles of inventive concepts, the range-determination process may start with the interrogator transmitting at highest power level possible in order to provoke an answer to the page and to thereby establish the continuing operation of both the transponder phone (that is, range transceiver 104) as well as the interrogation unit 102 and then reduce the paging power level (i.e., reduce the baiting beacon power level) and repeat the page. The interrogator 102 will repeat this process until the transponder phone(s) 104 no longer responds. In exemplary embodiments, the level at which the phone 104 stops responding is taken as the calibrated maximum level of operation for that particular baiting beacon. In an exemplary embodiment in accordance with principles of inventive concepts, this range-determination process may be repeated for all of the phones 104 in the transponder unit 108 separately, thereby establishing the optimum signal levels for each. Alternatively, as described above, the interrogator 102 may begin the range determination process with minimal power and repeat the process by increasing power until the transponder responds, then backing off that power level (or other transmission parameter) to provide margin for the calibrated maximum level of operation for that baiting beacon.

The particulars of the paging response of a phone will vary between cellular standards. However, they either directly or indirectly enable the interrogator transceiver 102 to determine that a phone response is expressly an answer-to-page, as opposed to some other activity. Other activity, activity which the system distinguishes, may include registration, which may inadvertently occur if cell phones other than transponder (that is, range-determination), phones 104 interact with the interrogator. Because, in accordance with principles of inventive concepts, the baiting beacon is the only source of paging directed at the transponder phones and the paging is directed only at those phones, other phones will not respond to those pages and, therefore there are no inadvertent false alarms, as there would be if other phones were to attempt to interact with the baiting beacon.

In accordance with principles of inventive concepts, individual phones 104 in a transponder unit 108 may be replaced by a phone emulation transceiver that can mimic the collective operation of the individual phones 104, in tandem or, perhaps, simultaneously, for example.

In exemplary embodiments in accordance with principles of inventive concepts a system 100 may include full interrogation of the phones 104 in the transponder unit 108 after contending with problem of filtering for all of the phones that may attempt to register simultaneously. The use of non-engineering phones (that is, phones that do not include engineering-mode capabilities) that cannot be forced to operate on a particular band is also contemplated within the scope of inventive concepts and in such embodiments, additional suppression measures may be applied to one or more bands in order to force phones to, operate on a desired band to thereby expressly calibrate the interrogator operating on that band.

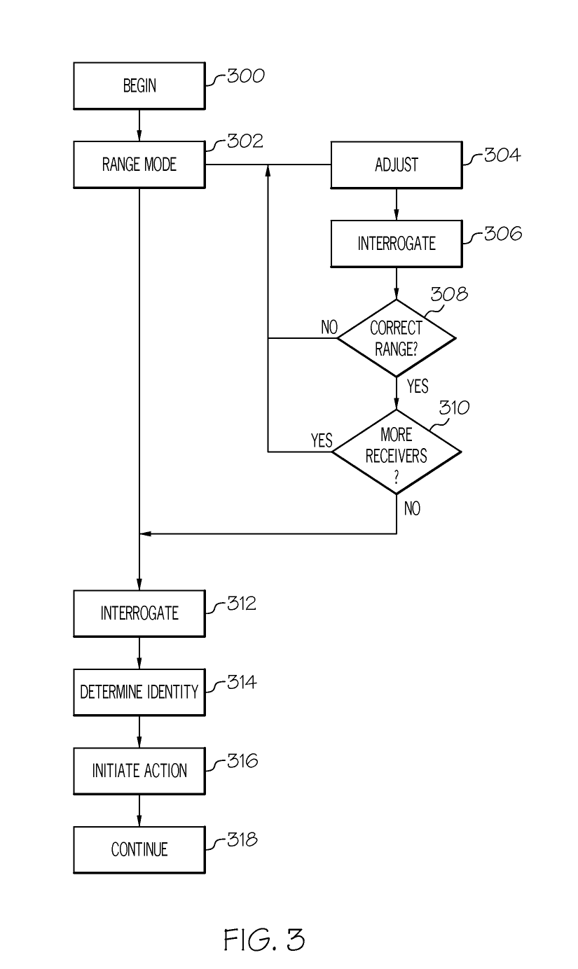

The flow chart of FIG. 3 depicts execution of an exemplary method in accordance with principles of inventive concepts. In accordance with principles of inventive concepts a processor 106 may be coupled to an interrogator 102 to control operation of the interrogator 102. The combination may operate in a range-determination, or interrogation mode, for example. In a range-determination mode, the processor 106 may establish an appropriate range for the interrogator signal, as described above, for example. In a “normal” interrogation mode, the interrogator baits illicit cell phones within a prohibited area. The process begins in step 300 and proceeds from there to step 302 where the process determines whether to operate in a range-determination mode, or in an interrogation mode. The processor may enter a range-determination mode on a timed basis (which may be regular or intermittent), and/or may respond to environmental factors, such as weather conditions or solar storms, for example to initiate range-determination.

If, in step 302 the process determines that the system 100 is to operate in the range-determination mode, the process proceeds to step 304, where transmission parameters, such as power level associated with transceiver 102 are adjusted to an initial level. As previously described, this initial level (if power) may be a minimum or maximum level, depending upon whether the process is to be a “creep up” or “creep down” method. Additionally, if more than one range transceiver 104 is employed, the identity and other characteristics, such as the channel employed by the transceiver, may be used initialize the range-setting process. In accordance with principles of inventive concepts, an interrogator may attempt to gain the attention of each phone (or equivalent) operating within a transponder unit and thereby determine at what level the interrogator can safely operate without affecting phones that are outside a prohibited area within which the interrogator is located. In accordance with principles of inventive concepts, the interrogator transceiver generates a signal designed to gain the attention of a particular phone (that is, for example, one of the range transceivers 104) and then attempts to page the phone in step 306. If the phone responds, the power is continually lowered, cycling through steps 304 through 308 until the phone stops responding to the page. This process may be repeated for each service provider on each band (i.e., the representative phone for each is paged), cycling through steps 304 through 310 to calibrates the proper power level and/or other interrogator transceiver characteristic for each range transceiver 104.

After calibrating the interrogator 102 using the various range transceivers, the process proceeds from step 310 to step 312, where the system 100 enters an interrogation mode. In this mode of operation, in step 312 the interrogator 102 interrogates cellular devices within its range, for example, by paging devices using the various channels and service provider characteristics which were calibrated in the calibration mode. For devices that respond to such interrogation, the system 100 obtains identity information from the device and, either locally, or through cooperation with service providers, identifies the offending devices in step 314. Once an illicit cellular device is identified in step 314, the process proceeds to step 316, where the system 100 initiates a response, which may take the form of, for example, inducing the device's service provider to terminate service to the device.

From step 316, the process may proceed to step 318, where the system 100 continues to monitor the use-prohibited area, returning to the range mode to calibrate the transceiver under control of processor 106. That is, in accordance with principles of inventive concepts, processor 106 may be employed to adapt to changing network conditions. For example, service providers routinely reallocate the cellular spectrum. Other conditions such as weather or seasons can also materially affect signal levels. Either can in turn materially affect the signal level required to perform interrogation. A system and method in accordance with principles of inventive concepts may therefore automatically rescan the environment regularly to detect changes and subsequently performs anew the aforementioned paging/range-determination routine to constantly adapt characteristics of the system 100, such as power levels, to improve performance. The processor may also be employed to regularly determine that both the interrogator transceiver 102 and range transceivers 104 are operating properly.

While the present inventive concepts have been particularly shown and described above with reference to exemplary embodiments thereof, it will be understood by those of ordinary skill in the art, that various changes in form and detail can be made without departing from the spirit and scope of the present inventive concepts described and defined by the following claims.

1. A method in a cellular communications system, comprising:
an interrogating transceiver calibrating itself by transmitting a cellular signal from within a use-prohibited area;
a range transceiver receiving the signal; and
the interrogating transceiver adjusting the range of its signals according to a response from the range transceiver.

2. The method of claim 1, wherein the interrogating transceiver adjusts the range of its signals by adjusting the power level of its transmissions.

3. The method of claim 2, wherein the interrogating transceiver adjusts the range of its signals by setting its power output level to high level and adjust the power output level downward until a range transceiver no longer responds to its interrogation signal.

4. The method of claim 2, wherein the interrogating transceiver adjusts the range of its signals by setting its power output level to low level and adjust the power output level upward until a range transceiver responds to its interrogation signal.

5. The method of claim 2, further comprising an interrogating transceiver adjusting the range of its signals according to responses from a plurality of range transceivers.

6. The method of claim 5, wherein identities of the plurality of range receivers is stored by the interrogating transceiver and the identities are employed by the interrogating transceiver to avoid interaction with cellular devices outside the use-prohibited area other than the range transceivers.

7. The method of claim 5, wherein different range transceivers are assigned to different service providers.

8. The method of claim 5, wherein different range transceivers are assigned to different cellular transmission channels.

9. A method in cellular communications system, comprising:
an interrogating transceiver calibrated using a range transceiver outside a use-prohibited area baiting cellular devices;
the interrogating transceiver obtaining identity information from cellular devise that signal in response to the baiting signals;
the interrogating transceiver identifying responding cellular devices; and
the interrogating transceiver initiating a response to identified cellular devices operating within a use-prohibited area.

10. The method of claim 9, wherein the response initiated by the interrogating transceiver is termination of service.

11. A cellular communications system, comprising:
an interrogating transceiver positioned within a use-prohibited area; and
a range transceiver positioned outside the use-prohibited area, wherein the interrogating is configured to be calibrated by transmitting a cellular signal from within a use-prohibited area, the range transceiver receiving the signal, and the interrogating transceiver adjusting the range of its signals according to a response from the range transceiver.

12. The cellular communications system of claim 11, wherein the interrogating transceiver is configured to adjust the range of its signals by adjusting the power level of its transmissions.

13. The cellular communications system of claim 12, wherein the interrogating transceiver is configured to adjust the range of its signals by setting its power output level to high level and adjusting the power output level downward until a range transceiver no longer responds to its interrogation signal.

14. The cellular communications system of claim 12, wherein the interrogating transceiver is configured to adjust the range of its signals by setting its power output level to low level and adjusting the power output level upward until a range transceiver responds to its interrogation signal.

15. The cellular communications system of claim 12, further comprising an interrogating transceiver configured to adjust the range of its signals according to responses from a plurality of range transceivers.

16. The cellular communications system of claim 15, wherein the interrogating transceiver is configured to store identities of the plurality of range receivers and to use the identities to avoid interaction with cellular devices outside the use-prohibited area other than the range transceivers.

17. The cellular communications system of claim 15, further comprising a plurality of range transceivers, each configured for a different service provider.

18. The cellular communications system of claim 15, further comprising a plurality of range transceivers, each configured for a different cellular transmission channels.

19. The cellular communications system of claim 11, further comprising:
an interrogating transceiver configured to obtain identity information from cellular device that signals in response to a baiting signal;
the interrogating transceiver configured to identify responding cellular devices; and
the interrogating transceiver configured to initiate a response to identified cellular devices operating within a use-prohibited area.

20. The cellular communications system of claim 19, wherein the interrogating transceiver is configured to initiate termination of service.
